(19) United States
(12) Patent Application Publication
(10) Pub. No.: US 2006/0172161 A1
(43) Pub. Date: Aug. 3, 2006

(54) Reformer for fuel cell and fuel cell system

(75) Inventors: Toshihisa Ueda, Yokohama-shi (JP); Daesu Jun, Yokohama-shi (JP); Kenichiro Matsumoto, Yokohama-shi (JP); Takahiro Nakajima, Yokohama-shi (JP); Yasuo Ido, Inuyama-shi (JP); Shoji Nawa, Inuyama-shi (JP); Yukio Naruse, Inuyama-shi (JP); Shigeru Inami, Inuyama-shi (JP)

Correspondence Address: AMIN & TUROCY, LLP, 1900 EAST 9TH STREET, NATIONAL CITY CENTER, 24TH FLOOR,, CLEVELAND, OH, 44114, US

(73) Assignees: Keio University, Minato-ku (JP); Daido Metal Company Ltd., Naka-ku (JP)

(21) Appl. No.: 11/343,482

(22) Filed: Jan. 31, 2006

(30) Foreign Application Priority Data
Feb. 1, 2005 (JP) 2005-025541

(51) Int. Cl. H01M 8/06; B01J 8/02

(52) U.S. Cl. 429/20; 422/211

(57) ABSTRACT

The reformer 100 includes: an evaporating unit 102 that has a source fuel inlet 114 through which hydrocarbon-containing source fuel 202 is introduced, and is capable of evaporating a source fuel 202 introduced through the source fuel inlet 114; a catalyst containing unit 104 that is provided in the evaporating unit 102 and stores a reforming catalyst 108, which is capable of inducing a reaction for reforming the source fuel 202 into a reformed fuel having higher hydrogen amount; and a hydrogen outlet 118 that is provided on the catalyst containing unit 104 so as to communicate with the catalyst containing unit 104.

This application is based on Japanese patent application No. 2005-25,541, the content of which is incorporated hereinto by reference.

### BACKGROUND

1. Technical Field

The present invention relates to a reformer for a fuel cell and a fuel cell system.

2. Related Art

Fuel cells have higher energy density and higher effectiveness in heat exchange, as compared with lithium-ion batteries that are currently employed as a general power supply for electronic equipments such as personal computers, and therefore practical uses thereof as a power supply in place of the lithium-ion battery are now examined.

Fuel cell is configured of a fuel electrode, an oxygen electrode and an electrolyte provided therebetween, and a fuel is supplied to the fuel electrode and an oxidizing agent is supplied to the oxygen electrode to generate electricity via an electrochemical reaction. Hydrogen is generally employed for the fuel, and in recent years, in order to achieve utilizing methanol that is not expensive and easier to be handled as a raw material for hydrogen, developments in methanol-reformed fuel cells that are capable of generating hydrogen by reforming methanol are actively conducted.

When hydrogen is employed as the fuel, reaction occurred at a fuel electrode may be presented as follows:
3H₂→6H⁺+6e⁻ (1)

Reaction occurred at the oxygen electrode may be presented as follows:
3/2O₂+6H⁺+6e⁻→3H₂O (2)

Known processes for generating hydrogen by reforming the source fuel such as methanol and the like include, for example, steam reforming, partial oxidation reforming, and other reforming processes jointly utilizing these reforming processes. Among these, practical realization of the steam reforming process, which involves reacting the source fuel and water vapor to obtain hydrogen gas, is broadly proceeded.

A reaction in a steam reforming process may be presented as follows:
CH₃OH+H₂O→CO₂+3H₂ (3)

Japanese Patent Laid-Open Application No. 2002-241,105 discloses a fuel reformer, which includes a starting-up combustion device for combusting methanol and air to supplying a high-temperature gas, a reformer for generating a reformed gas from the high-temperature gas on start-up, a carbon monoxide eliminating device for removing carbon monoxide in the reformed gas to a level that is equal to or lower than a predetermined concentration, an exhaust hydrogen combustion device for combusting the exhausted reformed gas and an exhausted air, which are exhausted from a fuel cell stack, and an evaporating device for vaporizing methanol and water by utilizing a heat of the combustion gas exhausted from the exhaust hydrogen combustion device. In this case, the fuel reformer is provided between the starting-up combustion device and the reformer, and the fuel reformer further includes a mixer for mixing the high-temperature gas, methanol and air, a switching valve provided between the starting-up combustion device and the mixer for switching a communication between the starting-up combustion device and the reformer to a communication between the starting-up combustion device and the exhaust hydrogen combustion device or vice versa, and a control unit for controlling the switching of the switching valve, such that the control unit switches the switching valve depending upon the operating state of the starting-up combustion device, thereby controlling the communication between the starting-up combustion device and the reformer and the communication between the starting-up combustion device and the exhaust hydrogen combustion device.

In the meantime, the conventional reformer is provided with, for example, an evaporating device for evaporating a source fuel and/or a CO eliminator that is capable of reducing carbon monoxide contained in a reformed gas to a level of a predetermined concentration, separately from the reformer body that contains a reforming catalyst, and these devices are connected through piping or the like, and therefore a problem of requiring a complicated structure is caused. Thus, loss of source fuel and reforming fuel may be occurred.

### SUMMARY OF THE INVENTION

The present invention is made on the basis of such circumstances, and an object of the invention is to provide a technology for reforming a hydrocarbon-containing source fuel into a reformed fuel that contains higher amount of hydrogen with a simple constitution.

According to the present invention, there is provided a reformer or reforming device for a fuel cell, including: an evaporating unit having a source fuel inlet, through which a hydrocarbon-containing source fuel is introduced, the evaporating unit being capable of evaporating the source fuel introduced through the source fuel inlet; a catalyst containing unit provided above the evaporating unit so as to communicate with the evaporating unit, the catalyst containing unit being capable of storing a reforming catalyst that promotes reforming the source fuel into a reformed fuel containing higher amount of hydrogen; and a reformed fuel outlet provided above the catalyst containing unit so as to communicate with the catalyst containing unit.

Having such configuration, the source fuel introduced to the evaporating unit can be transferred to the upper side via natural convection, where the source fuel is reformed within the catalyst containing unit, and therefore, the source fuel can be converted into the reformed fuel with an improved efficiency, without a need for employing a driving facility such as pump and the like. This provides a simple configuration of the reformer.

The reformer according to the present invention may further have a configuration, in which the evaporating unit and the catalyst containing unit are arranged in this sequence from underneath toward an upper vertical direction to form a vertical arrangement.

Having such configuration, the source fuel vaporized in the evaporating unit can be smoothly transferred to the catalyst containing unit via natural convection. Further, since the evaporating unit and the catalyst containing unit are vertically arranged, unreacted source fuel that has been moved to the catalyst containing unit is condensed when the reformer is cooled in a downtime of the reformer, and the condensed source fuel is transferred downward, and then is returned to the evaporating unit. This prevents the contamination of the interior of the reformer.

The reformer according to the present invention may further have a configuration, in which a passage for the fuel has a constant width and is linearly formed.

As such, loss of the fuel during the transportation can be reduced by presenting the constant and fixed fuel passage over the whole apparatus, thereby providing an improved conversion efficiency from the source fuel to the reformed fuel. Further, contamination of the interior of the reformer with the fuel can be prevented. Further, more simple design of the reformer can be presented, thereby providing a simple configuration.

The reformer according to the present invention may further have a configuration, which further includes a heater provided in a periphery of the evaporating unit and the catalyst containing unit.

The reformer according to the present invention may further have a configuration, which further includes a hydrogen separation unit provided between the catalyst containing unit and the reformed fuel outlet, the hydrogen separation unit being capable of conducting a processing for enhancing a amount of hydrogen in the reformed fuel that is produced by reforming in the catalyst containing unit.

Having such configuration, unwanted gases such as carbon monoxide, carbon dioxide and the like, which is contained in the reformed fuel produced by the reforming process in the catalyst containing unit, can be eliminated from the reformed fuel to enhance a purity of the reformed fuel. When the hydrogen separation unit is provided in the reformer, the reformer may include a vertical arrangement, in which the evaporating unit, the catalyst containing unit, and the hydrogen separation unit are arranged in this sequence from underneath toward an upper vertical direction. Further, in the reformer according to this aspect, the passage for the fuel including the hydrogen separation unit may have a constant width and may be linearly formed.

The reformer according to the present invention may further have a configuration, in which the hydrogen separation unit includes a hydrogen permeable membrane that is capable of selectively permeating hydrogen.

The reformer according to the present invention may further have a configuration, in which the hydrogen separation unit contains a preferential oxidization catalyst that is capable of selectively oxidizing carbon monoxide in the reformed fuel reformed in the catalyst containing unit.

The reformer according to the present invention may further have a configuration, in which the catalyst containing unit includes a retaining plate for retaining the reforming catalyst on a surface that is substantially parallel to a wall of the catalyst containing unit.

Having such configuration, contacting efficiency between the source fuel and the reforming catalyst can be enhanced when the source fuel is transported through the catalyst containing unit, thereby promoting the reform of the source fuel with an improved efficiency.

The reformer according to the present invention may further have a configuration, in which the retaining plate retains a plurality of agglomerates containing the reforming catalyst in mutual relationships of being spaced apart from each other.

Having such configuration, contacting efficiency between the source fuel and the reforming catalyst can be enhanced when the source fuel moves through the catalyst containing unit, thereby promoting the reform of the source fuel with an improved efficiency. Here, the retaining plate may have a configuration, in which a plurality of apertures spaced apart from each other are formed. In the catalyst containing unit, the apertures of the retaining plate thus configured may retain pelletized catalysts, respectively. Alternative configuration may be that, for example, a catalyst paste is disposed to form a pattern such as a matrix pattern, a zigzag pattern and the like on the surface of the retaining plate having no aperture, and the patterned paste is hardened.

The reformer according to the present invention may further have a configuration, in which the evaporating unit and the catalyst containing unit are housed in a housing including a pair of parallel flat plates and having a rectangular bottom surface, and wherein a flow rate of the source fuel evaporated in the evaporating unit is defined by a length of a longer side of the rectangular bottom surface.

Having such configuration, design of the reformer can be facilitated. Further, desired flow rate of the source fuel can be established by appropriately designing the dimension of the reformer.

The reformer according to the present invention may further have a configuration, in which the evaporating unit and the catalyst containing unit are housed in a cylinder-shaped housing.

Having this configuration, the strength of the reformer can be enhanced.

The reformer according to the present invention may further have a configuration, which further includes a source fuel storing vessel, which is connected to the source fuel inlet and contains a compressed gas and the source fuel.

Having such configuration, the source fuel can be supplied in the evaporating unit of reformer without a need for providing a driving device such as a pump and the like, thereby presenting more simple constitution of the reformer. Here, the source fuel containing device may be installed directly on the evaporating unit of the reformer, or may be installed thereto through the source fuel introduction tube or the like.

According to the present invention, there is provided a fuel cell system, including: any one of the aforementioned reformers; and a fuel cell including a fuel electrode being supplied with a reformed fuel transported from the reformed fuel outlet of the reformer and an oxygen electrode being supplied with an oxidizing agent.

According to the present invention, a hydrocarbon-containing source fuel can be reformed into a reformed fuel that contains higher amount of hydrogen with a simple constitution.

### BRIEF DESCRIPTION OF THE DRAWINGS

The above and other objects, advantages and features of the present invention will be more apparent from the following description taken in conjunction with the accompanying drawings, in which:

FIG. 1 is a schematic diagram, illustrating a configuration of a reformer in an embodiment;

FIGS. 2A and 2B are diagrams, illustrating a configuration of the reformer in the embodiment;

FIG. 3 is a schematic diagram, illustrating a condition of supplying the reformed fuel produced by reforming in the reformer of the embodiment into the fuel cell;

FIG. 4 is a schematic diagram, showing an example of an use of the reformer in the embodiment;

FIGS. 5A and 5B are diagrams, illustrating the constitution of the reformer in the embodiment;

FIG. 6 is a perspective view, illustrating an internal configuration of the reformer in the present embodiment;

FIGS. 7A to 7C are diagrams, illustrating a configuration of a retaining plate;

FIGS. 8A and 8B are diagrams, illustrating a configuration of a reformer employed in an example;

FIGS. 9A to 9C are tables showing results obtained in examples;

FIGS. 10A and 10B are diagrams, illustrating a reformer in an embodiment; and

FIG. 11 is a diagram, illustrating a reformer in an embodiment.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Preferable embodiments according to the present invention will be described in further detail, in reference to the annexed figures. In all figures, an identical numeral is assigned to an element commonly appeared in the figures, and the detailed description thereof will not be repeated.

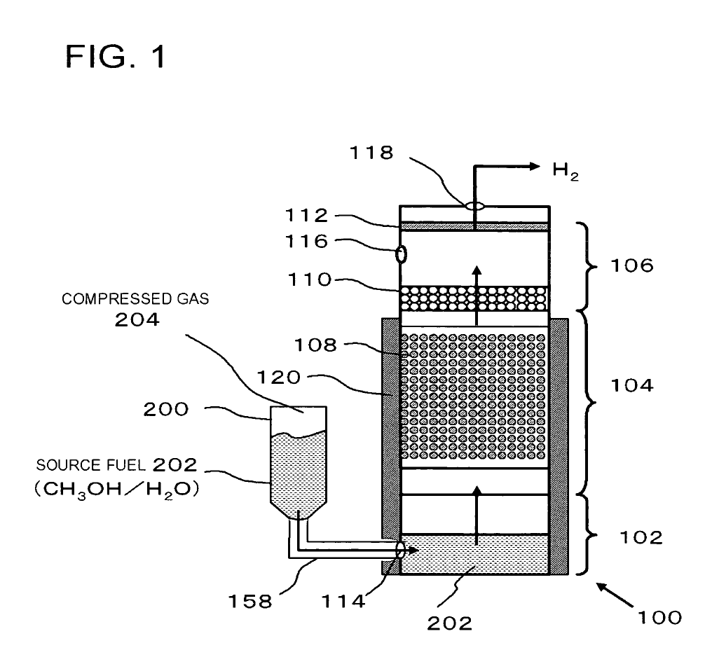

FIG. 1 is a schematic diagram illustrating constitution of a reformer 100 in the present embodiment. The reformer 100 includes an evaporating unit 102, a catalyst containing unit 104, a hydrogen separation unit 106 and a heater 120 for heating the evaporating unit 102 and the catalyst containing unit 104. The reformer 100 includes a vertical arrangement, in which the evaporating unit 102, the catalyst containing unit 104 and the hydrogen separation unit 106 are arranged in this sequence from underneath toward an upper vertical direction.

The evaporating unit 102 includes a source fuel inlet 114, through which a source fuel is introduced. The source fuel inlet 114 is connected to a source fuel containing tank 200 through a source fuel introduction tube 158. The source fuel containing tank 200 contains a source fuel 202 and a compressed gas 204. In the present embodiment, the source fuel 202 is an aqueous mixture of methanol (CH₃OH) and water (H₂O). Methanol concentration in such aqueous mixture may be selected to satisfy a relationship of, for example, methanol:water=1:1 (molar ratio), or to provide a relative amount of water over methanol of equal to or higher than 1 (molar ratio). However, methanol concentration in the aqueous mixture is not limited thereto, and the relative amount of water to methanol may alternatively be lower than 1 (molar ratio), according to other conditions. The source fuel containing tank 200 may be, for example, a pressurized can having an exhaust-nozzle. In such case, a mounting portion (not shown) of the source fuel containing tank 200 is provided on the source fuel introducing tube 158, and the exhaust-nozzle of the source fuel containing tank 200 is configured so as to be opened when the source fuel containing tank 200 is mounted to the mounting portion of the source fuel introduction tube 158. When the exhaust-nozzle of the source fuel containing tank 200 is opened, the source fuel 202 flows out into the source fuel introduction tube 158 from the source fuel containing tank 200 by a pressure of the compressed gas 204 contained in the source fuel containing tank 200.

The catalyst containing unit 104 stores a reforming catalyst 108 that promotes reforming the source fuel into the reformed fuel having higher amount of hydrogen. The reforming catalyst 108 may be, for example, CuO—Al₂O₃ or CuO—ZnO—Al₂O₃.

The heater 120 is provided in the periphery of the evaporating unit 102 and the catalyst containing unit 104. The source fuel 202 introduced through the source fuel inlet 114 can be evaporated in the evaporating unit 102 by heating the evaporating unit 102 with the heater 120. The source fuel 202 vaporized in the evaporating unit 102 is transferred to the catalyst containing unit 104 disposed above the evaporating unit 102. Chemical reaction of steam reforming process described by the above formula (3) is induced in the catalyst containing unit 104, by heating the catalyst containing unit 104 with the heater 120 while supplying a vaporized gas of the source fuel 202 into the catalyst containing unit 104, such that the source fuel 202 is reformed into carbon dioxide (CO₂) and hydrogen (H₂). The reformed fuel produced by reforming in the catalyst containing unit 104 is transferred to the hydrogen separation unit 106.

Heating process in the heater 120 may be achieved by, for example, introducing a part of the reformed fuel, which is transported from the hydrogen outlet 118, into the heater 120 and combusting hydrogen contained therein. Further, at an initial stage for the heating process, the evaporating unit 102 and the catalyst containing unit 104 may be heated by supplying methanol contained in the source fuel 202 to the heater 120 and combusting the supplied methanol.

Alternatively, the heater 120 may be composed of, for example, a platinum body warmer commercially available under a trade name of “Hakkin Kairo” or “Peacock Pocket Warmer” from Hakkin Warmers Co., Ltd., Osaka Japan. Use of the Peacock Pocket Warmer eliminates a need for supplying the electric power for the heating, thereby providing more simple constitution of the reformer 100 and further convenience in handling of the reformer 100. Further, since the evaporating unit 102 and/or the catalyst containing unit 104 can be heated without employing the source fuel to be supplied to the reformer 100 or the reformed fuel generated in the reformer 100 in this case, efficiency of generating the reformed fuel by the reformer 100 can be enhanced.

In the meantime, following shift reaction may be occurred due to equilibrium among carbon monoxide, water vapor, carbon dioxide and hydrogen in the steam reforming process of the above-described formula (3):

(shift reaction)
CO+H₂O [symbol] CO₂+H₂ (4)

Due to such shift reaction, a very small amount of carbon monoxide is included in the reformed fuel that is transported from the catalyst containing unit 104 to the hydrogen separation unit 106. Since performances of the catalyst in the fuel electrode of the fuel cell is deteriorated when unwanted carbon monoxide is included in the reformed fuel, it is preferable to eliminate carbon monoxide from the reformed fuel. Further, it is also preferable to eliminate carbon dioxide that is generated together with hydrogen by the steam reforming process, in order to increase the amount of hydrogen in the reformed fuel. A processing for selectively separating hydrogen from the reformed fuel generated in the catalyst containing unit 104 to enhance the amount of hydrogen in the reformed fuel is conducted in the hydrogen separation unit 106.

The hydrogen separation unit 106 includes an oxidation catalyst 110, a hydrogen permeable membrane 112, a carbon dioxide discharging port 116 provided between the oxidation catalyst 110 and the hydrogen permeable membrane 112, and a hydrogen outlet 118. The oxidation catalyst 110 is, for example, a preferential oxidization (PROX) catalyst, which induces selectively oxidizing carbon monoxide to generate carbon dioxide. The hydrogen permeable membrane 112 is a membrane that is capable of selectively permeating hydrogen and blocking a permeation of carbon dioxide. In this case, the hydrogen permeable membrane 112 may be, for example, a porous membrane that includes pores formed therein, through which hydrogen is permeated and carbon dioxide is not permeated. The hydrogen permeable membrane 112 may be composed of, for example, metals or ceramics.

Carbon monoxide in the reformed fuel is oxidized to generate carbon dioxide when the reformed fuel introduced in the hydrogen separation unit 106 passes through the oxidation catalyst 110, thereby reducing carbon monoxide concentration in the reformed fuel. In addition, hydrogen amount in the reformed fuel can be further increased when the reformed fuel passes through the hydrogen permeable membrane 112. The reformed fuel having higher hydrogen amount that have passed the hydrogen permeable membrane 112 is introduced to the outside through the hydrogen outlet 118. In addition, gases other than hydrogen such as carbon dioxide and the like, which can not pass through hydrogen permeable membrane 112, are discharged to the outside through the carbon dioxide discharging port 116.

Although it is not shown in any of the figures, the source fuel inlet 114, the carbon dioxide discharging port 116 and the hydrogen outlet 118 of the reformer 100 may have configurations having anti-reflux valves provided along thereof, in order to prevent external air or the like from entering into the reformer 100 in a downtime of the reformer 100.

### First Embodiment

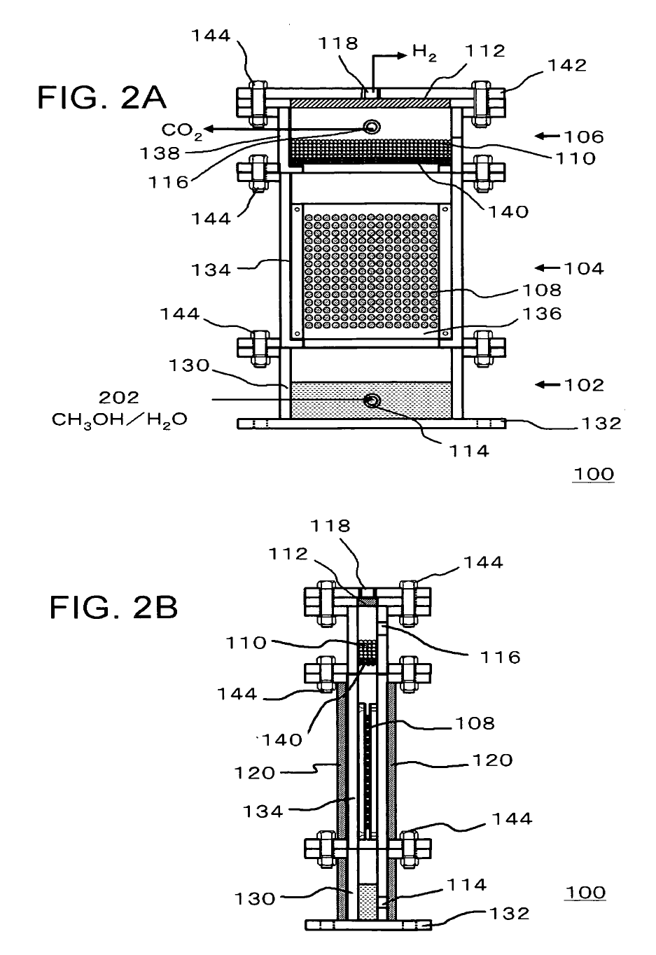

FIGS. 2A and 2B are diagrams, illustrating a constitution of a reformer in the present embodiment. FIG. 2A is a front cross-sectional view of the reformer 100. FIG. 2B is a side cross-sectional view of the reformer 100.

In the present embodiment, the reformer 100 includes a first housing 130, a second housing 134 and a third housing 138 for housing the evaporating unit 102, the catalyst containing unit 104 and the hydrogen separation unit 106, respectively. The first housing 130, the second housing 134 and the third housing 138 have rectangular bottom surfaces, in which longer side of the rectangle is sufficiently longer than the shorter side thereof, so that a flow rate of a source fuel 202 vaporized in the evaporating unit 102 can be determined by the length of the longer side. FIG. 2A shows the longer side of the rectangle, and FIG. 2B shows the shorter side of the rectangle.

In the present embodiment, the first housing 130, the second housing 134 and the third housing 138 are respectively composed of discrete housings, and fasteners 144 provide connections between the first housing 130 and the second housing 134 and between the second housing 134 and the third housing 138, respectively. A support plate 132 is provided on the bottom of the first housing 130. The first housing 130, the second housing 134 and the third housing 138 are vertically stacked by the support plate 132. In addition, an upper plate 142 provided with a hydrogen outlet 118 is disposed above the third housing 138. A hydrogen permeable membrane 112 is disposed between the third housing 138 and the upper plate 142, and these are fixed by fasteners 144.

A retaining plate 136 for retaining the reforming catalyst 108 is disposed in the catalyst containing unit 104. Here, the retaining plate 136 retains the reforming catalyst 108 on a surface that is substantially parallel to a wall of the catalyst containing unit 104. This allows enhancing contacting efficiency between the source fuel 202 and the reforming catalyst 108 when the source fuel 202 is transferred through the catalyst containing unit 104, thereby providing the reform of the source fuel 202 with an improved efficiency.

In addition, a plurality of pores are formed into a matrix pattern in the retaining plate 136. The retaining plate 136 may be composed of stainless steel, for example. Here, pelletized reforming catalysts 108 are inserted into the respective pores of the retaining plate 136. The retaining plate 136 retains a plurality of agglomerates of the reforming catalyst 108 in mutual relationships of being spaced apart from each other. Therefore, contacting efficiency between the source fuel 202 and the reforming catalyst 108 can be enhanced when the source fuel 202 moves through the catalyst containing unit 104, thereby promoting the reform of the source fuel 202 with an improved efficiency.

In the hydrogen separation unit 106, a porous sheet 140 for retaining pelletized oxidation catalysts 110 is disposed in the boundary region with the catalyst containing unit 104. This allows storing the oxidation catalyst 110 in the hydrogen separation unit 106.

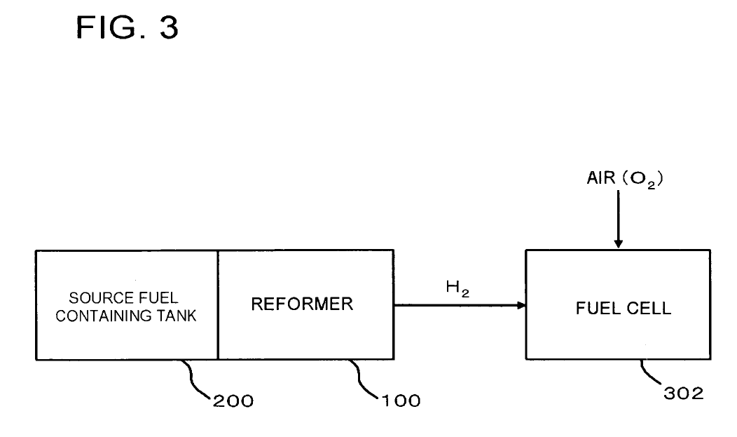

Next, operations of the reformer 100 in the present embodiment will be described. FIG. 3 is a schematic diagram, illustrating a condition of supplying the reformed fuel produced by reforming in the reformer 100 in the present embodiment into the fuel cell 302. Following descriptions will be made in reference to FIGS. 2A, 2B and FIG. 3.

A source fuel containing tank 200 is mounted on the reformer 100, and the source fuel 202 is supplied to the evaporating unit 102 of the reformer 100 from the source fuel containing tank 200. In this case, the evaporating unit 102 and the catalyst containing unit 104 of the reformer 100 are heated by the heater 120. This allows vaporizing the source fuel 202 supplied to the evaporating unit 102, and then being transferred to the catalyst containing unit 104 located above the evaporating unit 102. Vaporized source fuel 202 moves toward the above direction as it is. Since the catalyst containing unit 104 is also heated, chemical reaction of the steam reforming process described in the above formula (3) is induced in the catalyst containing unit 104, when the source fuel 202 passes through the reforming catalyst 108 retained in the retaining plate 136. This allows reforming the source fuel 202 into carbon dioxide (CO₂) and hydrogen (H₂).

The reformed fuel produced by reforming in the catalyst containing unit 104 is further transferred upward, and then is introduced into the hydrogen separation unit 106 located above the catalyst containing unit 104. A very small amount of carbon monoxide is included in the reformed fuel produced by the reform process using the reforming catalyst 108, and carbon monoxide is selectively oxidized to produce carbon dioxide, while the reformed fuel passes through the oxidation catalyst 110 disposed on the porous sheet 140. This allows eliminating carbon monoxide from the reformed fuel. The reformed fuel is transferred further upward, where hydrogen in the reformed fuel is selectively permeated through the hydrogen permeable membrane 112, and then is taken to outside from the hydrogen outlet 118. Gases, which can not be permeated through hydrogen permeable membrane 112, are discharged to the outside through the carbon dioxide discharging port 116. In the present embodiment, an opening diameter of the carbon dioxide discharging port 116 may be suitably designed so as to prevent hydrogen in the reformed fuel that have passed through the oxidation catalyst 110 from being discharged to the outside through the carbon dioxide discharging port 116, according to a flow rate of the source fuel 202 vaporized in the evaporating unit 102 and a hydrogen separability of the hydrogen permeable membrane 112.

The reformed fuel transported from the hydrogen outlet 118 of the reformer 100 is supplied to the fuel electrode of the fuel cell 302 through feeding tubes or the like. In addition, air is supplied to the oxygen electrode of the fuel cell 302. Having such operation, reactions of the above-described formula (1) and formula (2) are carried out in the fuel electrode and the oxygen electrode of the fuel cell 302, respectively, so that an electric power can be extracted from the fuel cell 302.

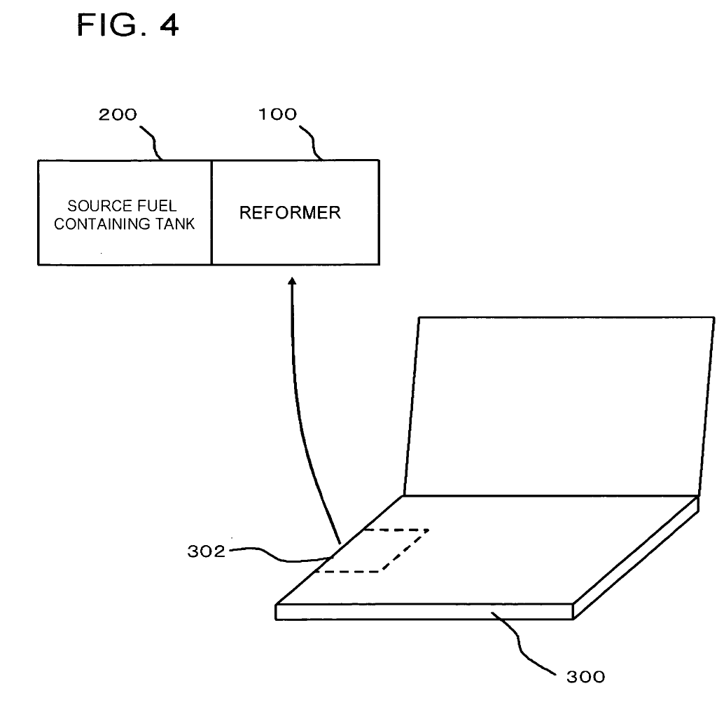

FIG. 4 is a schematic diagram, showing an example of an use of the reformer 100 in the present embodiment. Here, an exemplary implementation of supplying a fuel of the fuel cell 302 installed in a notebook personal computer 300 from the reformer 100 will be shown.

The reformer 100 may be vertically arranged on a horizontal place. In use of the reformer 100, the source fuel containing tank 200 is mounted on the reformer 100, and the source fuel 202 is supplied to the evaporating unit 102 of the reformer 100. Further, the fuel cell 302 is connected to the reformer 100 so that a reformed fuel transported from the hydrogen outlet 118 of the reformer 100 is supplied to the fuel electrode of the fuel cell 302. When heating of the reformer 100 by the heater 120 is started under such conditions, the source fuel 202 introduced into the evaporating unit 102 evaporates and is transferred upward, and correspondingly, the steam reforming process and the hydrogen separation processing described above are carried out. As described above, the evaporating unit 102, the catalyst containing unit 104 and the hydrogen separation unit 106 are vertically stacked in the reformer 100 according to the present embodiment. Therefore, the source fuel 202 or the reformed fuel is transferred upward by natural convection, and therefore the source fuel 202 can be reformed into the reformed fuel without a need for providing a driving device. Subsequently, the reformed fuel having higher hydrogen amount produced in the reformer 100 is supplied to the fuel electrode of the fuel cell 302. Air is supplied to the oxygen electrode of the fuel cell 302, where the supply of air induces a cell reaction of the fuel cell 302, thereby supplying an electric power to the notebook personal computer 300.

In the downtime of the reformer 100, heating by the heater 120 is stopped. Once the reformer 100 is cooled, unreacted source fuel 202 that has been transferred to the above of the reformer 100 is condensed to be liquid. Since the reformer 100 has the vertical arrangement in this case, the condensed source fuel 202 is transferred downwardly, and then is returned to the evaporating unit 102. Here, in the reformer 100, the passage for the fuel has a constant width and is linearly formed. Thus, remaining of the unreacted source fuel 202 in the catalyst containing unit 104 or the hydrogen separation unit 106 is prevented, and therefore the source fuel 202 is returned to the evaporating unit 102 without a loss. Further, since the unreacted source fuel 202 is not remained in the hydrogen separation unit 106 or the catalyst containing unit 104, potential contamination in the reformer 100 by the unreacted source fuel 202 can be prevented.

According to the reformer 100 in the present embodiment, a fuel for the fuel cell 302 can be produced with a simple constitution. Electric power can be supplied to electrical equipments such as notebook personal computer 300 and the like by disposing the reformer 100 in a desired location, even in the case of operating the electrical equipments at a place where there is not commercial power supply such as a plug socket and the like, and therefore convenience for users can be enhanced.

### Second Embodiment

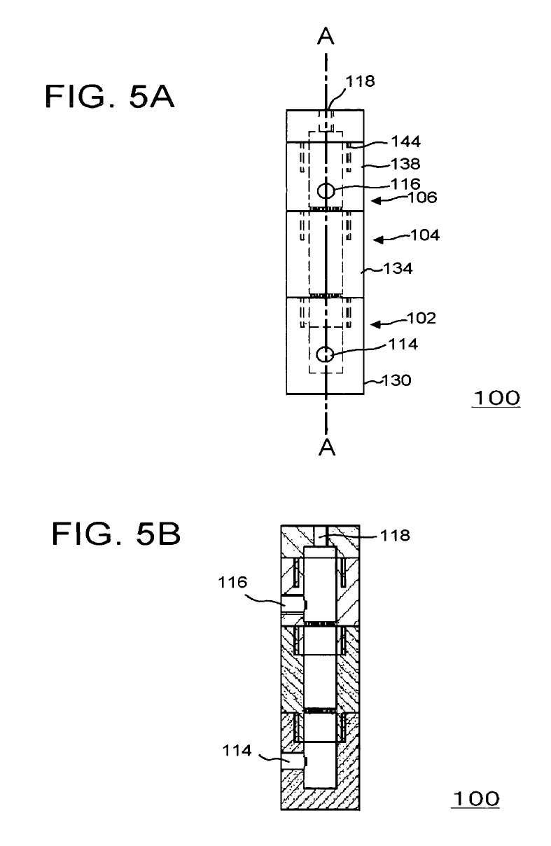

FIGS. 5A and 5B are diagrams, illustrating a constitution of a reformer in the present embodiment. FIG. 5A is an external view of a reformer 100. FIG. 5B is a cross-sectional view of the reformer 100.

In the present embodiment, the reformer 100 also includes a first housing 130, a second housing 134 and a third housing 138 for housing an evaporating unit 102, a catalyst containing unit 104 and a hydrogen separation unit 106, respectively. In the present embodiment, the first housing 130, the second housing 134 and the third housing 138 are formed to have cylindrical geometries. Having such configuration, strength of the reformer 100 can be enhanced.

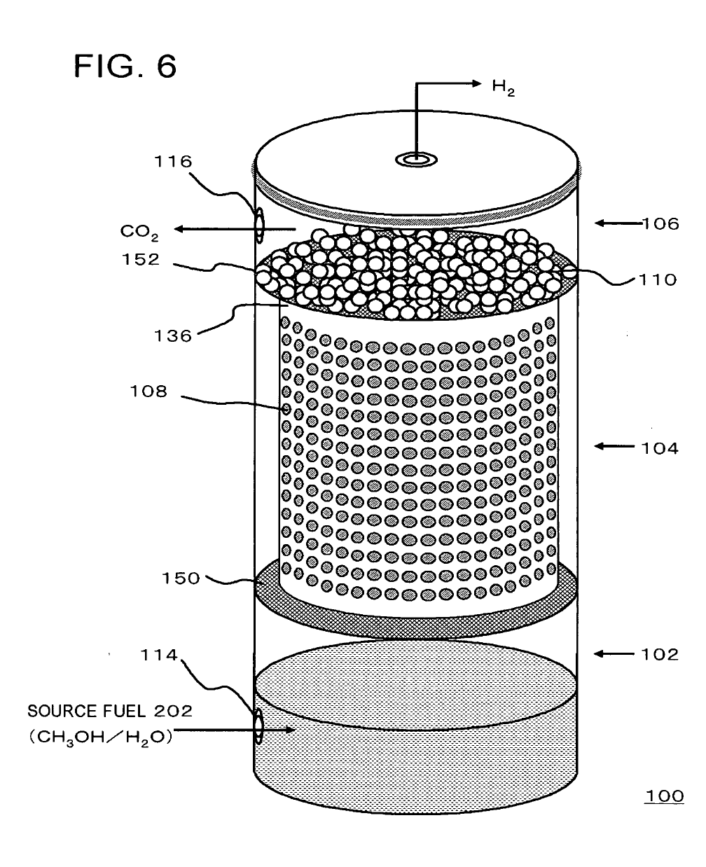

FIG. 6 is a perspective view, illustrating an internal configuration of the reformer 100 in the present embodiment. Here, a mesh sheet 150 and a mesh sheet 152 are disposed between the evaporating unit 102 and the catalyst containing unit 104 and between the catalyst containing unit 104 and the hydrogen separation unit 106, respectively. This can prevent a reforming catalyst 108 stored in the catalyst containing unit 104 from being transferred to the evaporating unit 102 and/or the hydrogen separation unit 106. Further, a configuration for preventing an oxidation catalyst 110 stored in the hydrogen separation unit 106 from being transferred to the catalyst containing unit 104 can also be presented.

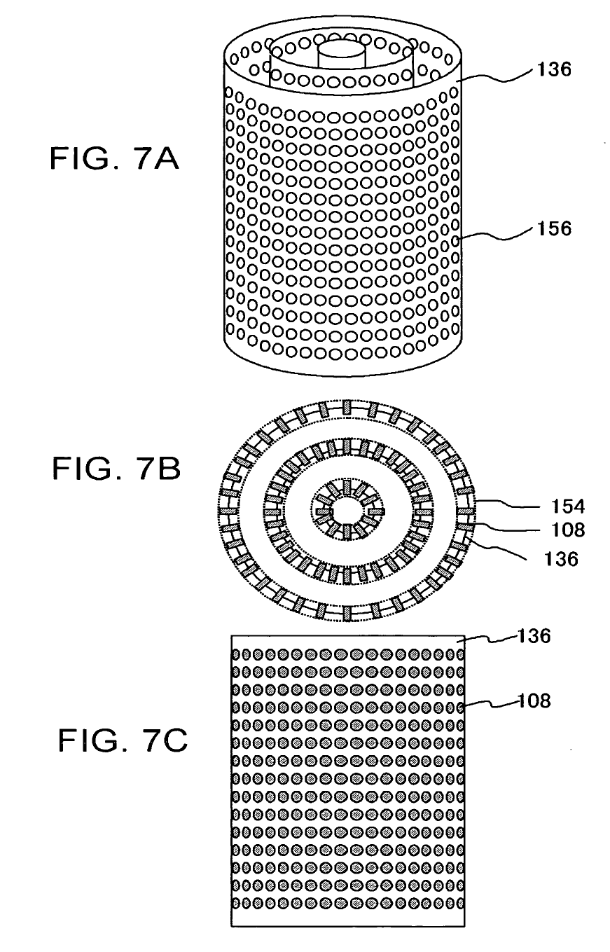

In the present embodiment, a retaining plate 136 may be formed to be cylindrical. FIGS. 7A to 7C are diagrams, illustrating a configuration of the retaining plate 136. FIG. 7A is a perspective view, illustrating the configuration of the retaining plate 136. Here, three retaining plates 136 of small, medium and large in sizes thereof are illustrated. A medium retaining plate 136 is disposed in the internal of a large retaining plate 136, and a small retaining plate 136 is disposed in internal of the medium retaining plate 136. A plurality of pores are formed into matrix patterns in the respective retaining plates 136. Each of these pores 156 is formed to have a dimension so as to retain the pelletized reforming catalyst 108.

FIG. 7B is a top plan view, illustrating a status for retaining the reforming catalyst 108 in the pores 156 of the retaining plate 136. Mesh sheets 154 for retaining the reforming catalyst 108 in the pores 156 of the retaining plate 136 are provided in the interiors of and on the outsides of these retaining plates 136, respectively. As such, displacement of the reforming catalysts 108 from the pores 156 of the retaining plate 136 can be prevented by disposing the mesh sheets 154 in the interiors of and on the outsides of these retaining plates 136.

FIG. 7C is a front view, illustrating a condition of retaining the reforming catalysts 108 in the pores 156 of the retaining plate 136. As such, utilization efficiency of the catalyst can be enhanced by retaining a plurality of pelletized reforming catalysts 108 to form a matrix-pattern.

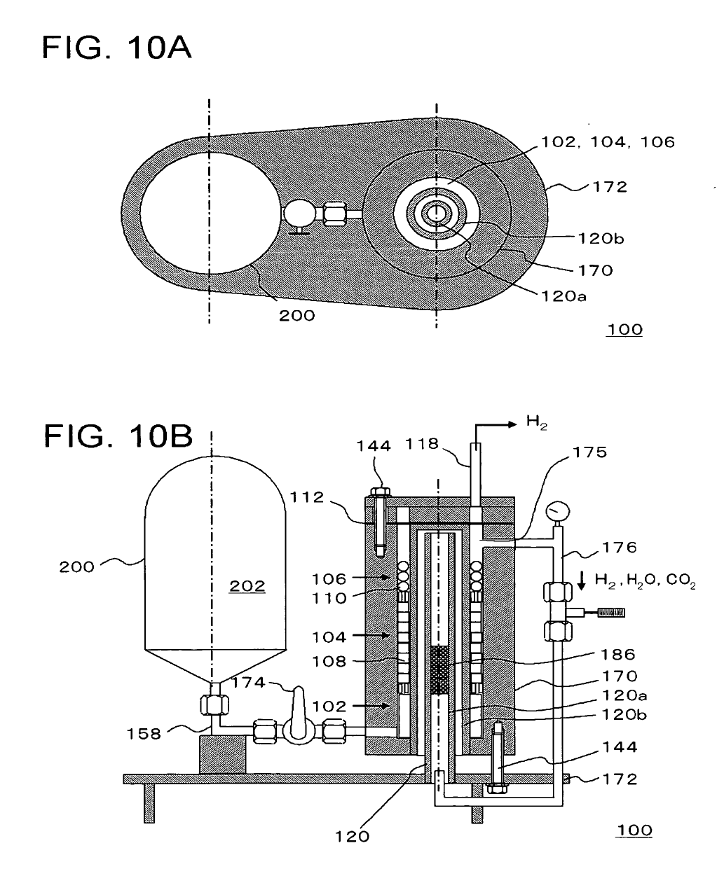

FIGS. 10A and 10B are diagrams, illustrating another exemplary implementation of the reformer 100 in the present embodiment. FIG. 10A is a schematic plan view of the reformer 100, and FIG. 10B is a side-view of the reformer 100. In this case, cross-sectional views are presented to show an interior of the cylindrical housing 170.

In this case, a heater 120 is disposed in the center of a cylindrical housing 170 having a cylinder shape, and circumference portion thereof is provided with the evaporating unit 102, the catalyst containing unit 104 and the hydrogen separation unit 106. The heater 120 includes an internal tube 120a and an external tube 120b disposed on the circumference thereof. In the hydrogen separation unit 106, between the oxidation catalyst 110 and the hydrogen permeable membrane 112 is provided with a gas discharging port 175, through which a portion of the reformed fuel and carbon dioxide that have been passed through the oxidation catalyst 110 are discharged to the fuel circulation tube 176. The fuel circulation tube 176 is connected to the internal tube 120a of the heater 120. Hydrogen combustion catalyst 186 is disposed in the internal tube 120a, where hydrogen, which is a reformed fuel introduced therein, is combusted to heat the gas contained in the internal tube 120a. Further, the gas that have passed through the internal tube 120a is discharged into the external tube 120b from the upper portion thereof, thereby introducing the heated gas into the external tube 120b. This achieves heating of the catalyst containing unit 104 and/or the evaporating unit 102.

The source fuel containing tank 200 and the cylindrical housing 170 are disposed on a supporter 172. The source fuel introduction tube 158 is provided with the valve 174, and the source fuel stored in the source fuel containing tank 200 can be supplied to evaporating unit 102 by opening and closing the valve 174.

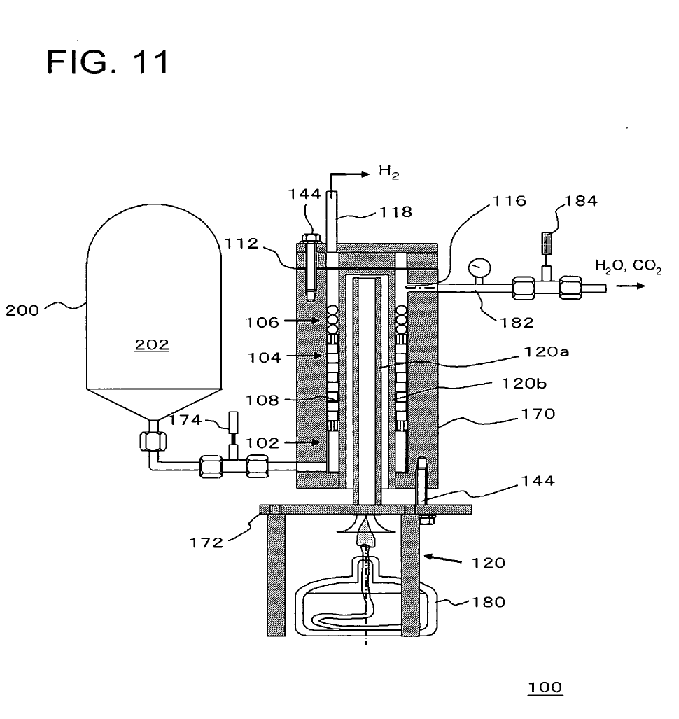

FIG. 11 is a diagram, illustrating yet other exemplary implementation of the reformer 100 in the present embodiment. The reformer 100 in this exemplary implementation also includes similar configuration as that of the reformer 100 shown in FIGS. 10A and 10B. A difference of this exemplary implementation from the exemplary implementation shown in FIGS. 10A and 10B is that an alcohol lamp 180 is employed for the heat source of the heater 120.

In this exemplary implementation, the alcohol lamp 180 is disposed under the cylindrical housing 170. The alcohol lamp 180 is disposed right under the internal tube 120a of the heater 120, such that air within the internal tube 120a is heated. Air heated in the internal tube 120a is discharged from the upper portion thereof to the external tube 120b, and thus heated air is also introduced into the external tube 120b. This provides heating of the catalyst containing unit 104 and/or the evaporating unit 102.

Further, a carbon dioxide discharging port 116 is provided between the oxidation catalyst 110 and the hydrogen permeable membrane 112 in the hydrogen separation unit 106, so that carbon dioxide that have passed through the oxidation catalyst 110 is discharged to the outside via a gas outlet tube 182 that is connected to the carbon dioxide discharging port 116. A valve 184 is provided along the gas outlet tube 182, and discharging of the gas can be controlled by opening and closing the valve 184.

The reformer 100 in the present embodiment may also be employed in a similar way as described in first embodiment.

In addition, the reformer 100 in the present embodiment also exhibits similar advantageous effects as described in first embodiment. Further, since the reformer 100 in the present embodiment is formed to have the cylindrical geometry, the strength thereof can be enhanced. In particular, when the hydrogen permeable membrane 112 is provided in the hydrogen separation unit 106, it is required to transport the reformed fuel from the hydrogen outlet 118 by creating higher pressure in the interior of the reformer 100. Even in such case, the reformer 100 having the cylindrical geometry has sufficient strength resistance.

### EXAMPLES

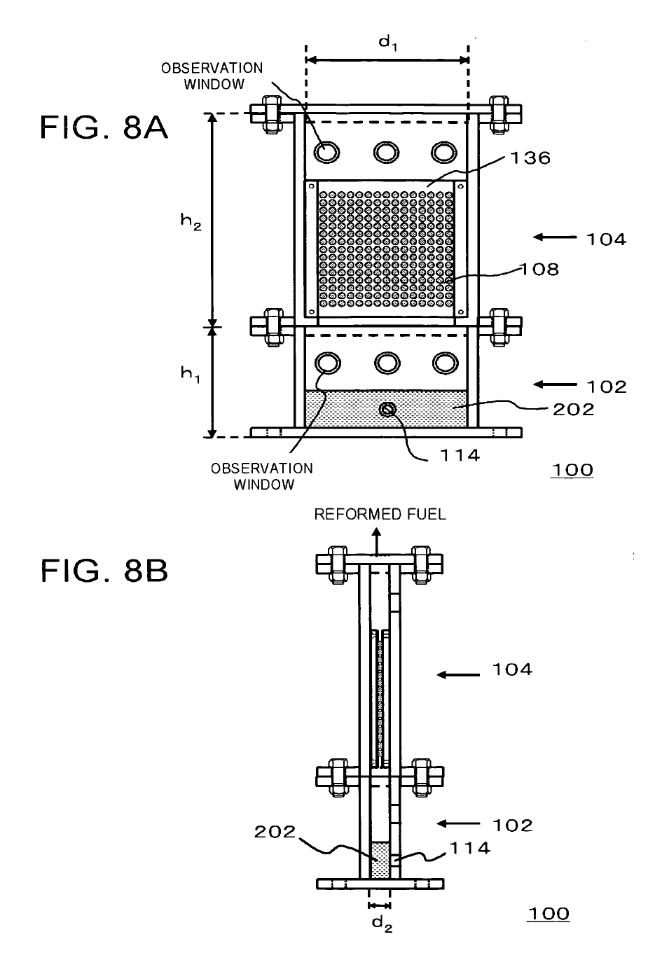

FIGS. 8A and 8B are diagrams, illustrating a configuration of a reformer employed in the present example. A reformer 100 employed in the present example has a configuration same as the reformer 100 described in first embodiment in reference to FIGS. 2A and 2B, except that a hydrogen separation unit 106 is not included. In addition, observation windows for measuring temperature or the like are provided in the upper portions of the evaporating unit 102 and the catalyst containing unit 104, respectively.

In the following examples, pelletized CuO—ZnO—Al₂O₃ (commercially available from Sued-Chemie Catalysts Japan Co., Ltd, Tokyo, Japan under the trade name of MDC-3) was employed for the reforming catalyst 108 to form a matrix pattern of 15 pellets×15 pellets. Height h1 of the evaporating unit 102 was h₁=63 mm; and height h₂ of the catalyst containing unit 104 was h₂=118 mm. In addition, length (longer side) d₁ of the reformer 100 shown in FIG. 8A was d₁=76.5 mm; and width (shorter side) d₂ of the reformer 100 shown in FIG. 8A was d₂=9.5 mm. Although it is not illustrated here, a ribbon heaters were wound around the peripheries of the evaporating unit 102 and the catalyst containing unit 104, and the evaporating unit 102 and the catalyst containing unit 104 were heated to about 150 degree C. and about 300 degree C., respectively.

A source fuel of a mixture of methanol and water was supplied to the evaporating unit 102 of the reformer 100 by employing a pump. In the steam reforming process, methanol and water are reacted at a molar ratio of 1:1, as described in formula (3). In each of the following examples, a source fuel was reformed via a steam reforming process at different mixing ratio of methanol and water. Mixing ratio of methanol and water is indicated by φ, which is obtained by dividing an actual mixing ratio by a theoretical mixing ratio (=1, indicated by subscription of ST).
φ=((methanol flow rate [mol/s]/water flow rate [mol/s]) /(methanol flow rate [mol/s]/water flow rate [mol/s])_{ST})

Here, methanol concentration is lower (lean) when φ<1, and methanol concentration is excessively higher (rich) when φ>1.

### Example 1

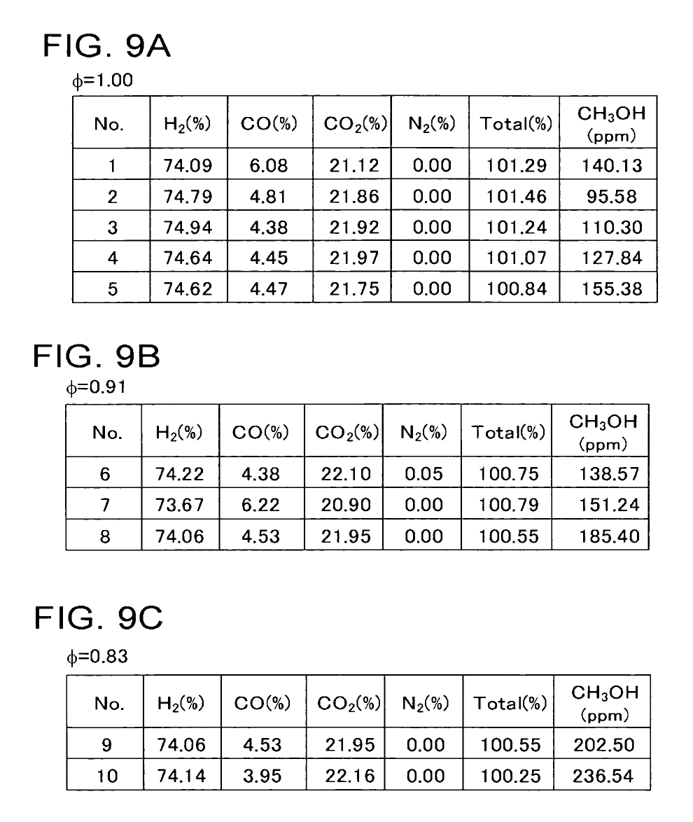

Methanol flow rate and water flow rate were selected so as to satisfy φ=1. A source fuel was reformed via the steam reforming process under such condition. Mole concentrations of hydrogen (H₂), carbon monoxide (CO), carbon dioxide (CO₂) and nitrogen (N₂) contained in the reformed fuel transported from the upper portion of the catalyst containing unit 104 were measured. The results were shown in FIG. 9A.

### Example 2

Methanol flow rate and water flow rate were selected so as to satisfy φ=0.91. The source fuel was reformed via the steam reforming process under such condition. Mole concentrations of hydrogen (H₂), carbon monoxide (CO), carbon dioxide (CO₂) and nitrogen (N₂) contained in the reformed fuel transported from the upper portion of the catalyst containing unit 104 were measured. The results were shown in FIG. 9B.

### Example 3

Methanol flow rate and water flow rate were selected so as to satisfy φ=0.83. A source fuel was reformed via the steam reforming process under such condition. Mole concentrations of hydrogen (H₂), carbon monoxide (CO), carbon dioxide (CO₂) and nitrogen (N₂) contained in the reformed fuel transported from the upper portion of the catalyst containing unit 104 were measured. The results were shown in FIG. 9C.

It was clarified that amount of hydrogen in the reformed fuel can be increased and amount of carbon monoxide can be decreased in each case. In particular, as demonstrated in example 3, it was clarified that carbon monoxide concentration in the reformed fuel can be decreased to equal to or lower than 5%, when water flow rate is larger than a theoretical mixing ratio. It is considered that this is because the shift reaction shown in formula (4) can be preferential to the right side of the formula by increasing water vapor concentration in the source fuel.

In addition, it is also considered that, in each example, amount of hydrogen in the reformed fuel can be further increased and amount of carbon monoxide can be further decreased by conducting a processing in the hydrogen separation unit 106 thereafter.

While the preferred embodiments of the present invention have been described above in reference to the annexed figures, it should be understood that the disclosures above are presented for the purpose of illustrating the present invention, and various configurations other than the above described configurations can also be adopted.

While the embodiment of having a plurality of pores that form the matrix pattern on the retaining plate 136 in the catalyst containing unit 104 is illustrated in the above-mentioned embodiment, a plurality of pores may alternatively be presented to form a pattern other than the matrix pattern such as, for example, zigzag pattern and the like. In addition, the reforming catalyst 108 is not limited to the form of the combination of the retaining plate provided with a plurality of pores therein and the pelletized catalysts. the reforming catalyst 108 may also be formed by, for example, arranging catalyst pastes in a pattern such as a matrix pattern or a zigzag pattern on the surface of the retaining plate having no pores therein and hardening the patterned paste.

Source fuels available in the present invention may include aqueous mixtures of water and oxygen-containing hydrocarbons such as methanol, ethanol, dimethylether, methylethyl ether and the like or mixtures thereof.

The above-described configurations of containing the evaporating unit 102, the catalyst containing unit 104 and the hydrogen separation unit 106 housed in the individual housings, respectively, are disclosed in the embodiments. Having such configuration, when a failure such as, for example, plugging of the pores and the like is occurred in any of the portions, necessary recovery can be easily conducted by disassembling thereof. In the meantime, as described above, in the reformer 100 of the present invention, unreacted source fuel 202 is not remained in the catalyst containing unit 104 and/or the hydrogen separation unit 106 and is returned to the evaporating unit 102, in the downtime of the reformer 100. Therefore, failures such as plugging of the pores caused by the unreacted source fuel 202 or the like is hard to be occurred. Accordingly, the evaporating unit 102, the catalyst containing unit 104 and the hydrogen separation unit 106 may alternatively be housed within one housing.

In addition, while first embodiment illustrates the example of supplying the reformed fuel transported from the reformer 100 to the fuel cell 302, which is separately installed in the notebook personal computer 300, in reference to FIG. 4, the reformer 100 may alternatively be installed together with other built-in equipments. For example, a fuel cell is incorporated in a vending machine, and the reformer 100 is installed together with the vending machine, such that the reformed fuel transported from the reformer 100 can be supplied to the fuel cell in the vending machine.

The reformer according to the present invention allows reforming a hydrocarbon-containing source fuel into a reformed fuel that contains higher amount of hydrogen with a simple constitution. Consequently, the reformer according to the present invention can be preferably employed as a reformer for supplying a fuel to the electrical equipment including a fuel cell that utilizes a fuel of hydrogen. In addition, the reformer according to the present invention can also be preferably employed for a fuel cell system that incorporates such reformer.

It is apparent that the present invention is not limited to the above embodiment, and may be modified and changed without departing from the scope and spirit of the invention.

What is claimed is:

1. A reformer for a fuel cell, comprising:
an evaporating unit having a source fuel inlet, through which a hydrocarbon-containing source fuel is introduced, said evaporating unit being capable of evaporating said source fuel introduced through said source fuel inlet;
a catalyst containing unit provided above said evaporating unit so as to communicate with said evaporating unit, said catalyst containing unit being capable of storing a reforming catalyst that promotes reforming said source fuel into a reformed fuel containing higher amount of hydrogen; and
a reformed fuel outlet provided above said catalyst containing unit so as to communicate with said catalyst containing unit.

2. The reformer according to claim 1, wherein said evaporating unit and said catalyst containing unit are arranged in this sequence from underneath toward an upper vertical direction to form a vertical arrangement.

3. The reformer according to claim 1, wherein a passage for the fuel has a constant width and is linearly formed.

4. The reformer according to claim 2, wherein a passage for the fuel has a constant width and is linearly formed.

5. The reformer according to claim 1, further comprising a heater provided in a periphery of said evaporating unit and said catalyst containing unit.

6. The reformer according to claim 2, further comprising a heater provided in a periphery of said evaporating unit and said catalyst containing unit.

7. The reformer according to claim 1, further comprising a hydrogen separation unit provided between said catalyst containing unit and said reformed fuel outlet, said hydrogen separation unit being capable of conducting a processing for enhancing an amount of hydrogen in said reformed fuel that is produced by reforming in said catalyst containing unit.

8. The reformer according to claim 2, further comprising a hydrogen separation unit provided between said catalyst containing unit and said reformed fuel outlet, said hydrogen separation unit being capable of conducting a processing for enhancing an amount of hydrogen in said reformed fuel that is produced by reforming in said catalyst containing unit.

9. The reformer according to claim 7, wherein said hydrogen separation unit includes a hydrogen permeable membrane that is capable of selectively permeating hydrogen.

10. The reformer according to claim 8, wherein said hydrogen separation unit includes a hydrogen permeable membrane that is capable of selectively permeating hydrogen.

11. The reformer according to claim 7, wherein said hydrogen separation unit contains a preferential oxidization catalyst that is capable of selectively oxidizing carbon monoxide in said reformed fuel reformed in said catalyst containing unit.

12. The reformer according to claim 9, wherein said hydrogen separation unit contains a preferential oxidization catalyst that is capable of selectively oxidizing carbon monoxide in said reformed fuel reformed in said catalyst containing unit.

13. The reformer according to claim 1, wherein said catalyst containing unit includes a retaining plate for retaining said reforming catalyst on a surface that is substantially parallel to a side wall of the catalyst containing unit.

14. The reformer according to claim 2, wherein said catalyst containing unit includes a retaining plate for retaining said reforming catalyst on a surface that is substantially parallel to a side wall of the catalyst containing unit.

15. The reformer according to claim 13, wherein said retaining plate retains a plurality of agglomerates containing said reforming catalyst in mutual relationships of being spaced apart from each other.

16. The reformer according to claim 14, wherein said retaining plate retains a plurality of agglomerates containing said reforming catalyst in mutual relationships of being spaced apart from each other.

17. The reformer according to claim 1, wherein said evaporating unit and said catalyst containing unit are housed in a housing including a pair of parallel flat plates and having a rectangular bottom surface, and wherein a flow rate of said source fuel evaporated in said evaporating unit is defined by a length of a longer side of said rectangular bottom surface.

18. The reformer according to claim 1, wherein said evaporating unit and said catalyst containing unit are housed in a cylinder-shaped housing.

19. The reformer according to claim 1, further comprising a source fuel storing vessel, which is connected to said source fuel inlet and contains a compressed gas and said source fuel.

20. A fuel cell system, comprising:
a reformer for a fuel cell, including:
an evaporating unit having a source fuel inlet, through which a hydrocarbon-containing source fuel is introduced, said evaporating unit being capable of evaporating said source fuel introduced through said source fuel inlet;
a catalyst containing unit provided above said evaporating unit so as to communicate with said evaporating unit, said catalyst containing unit being capable of storing a reforming catalyst that promotes reforming said source fuel into a reformed fuel containing higher amount of hydrogen; and
a reformed fuel outlet provided above said catalyst containing unit so as to communicate with said catalyst containing unit; and
a fuel cell including a fuel electrode being supplied with a reformed fuel transported from said reformed fuel outlet of said reformer and an oxygen electrode being supplied with an oxidizing agent.
